(19) United States
(12) Patent Application Publication
(10) Pub. No.: US 2015/0159786 A1
(43) Pub. Date: Jun. 11, 2015

(54) FRACTURING FLUID TRANSPORT HOSE, METHOD FOR MANUFACTURING SAME, AND CO-EXTRUSION MOULD

(71) Applicant: 5ELEM MATERIAL SCIENTIFIC (JIANGSU) CO., LTD., Taizhou, Jiangsu Province (CN)

(72) Inventors: Yuehua Sha, Taizhou (CN); Donghui Wang, Taizhou (CN); Jinma Wang, Taizhou (CN); Tingting Chen, Taizhou (CN); Shanhong Zhou, Taizhou (CN)

(21) Appl. No.: 14/350,275

(22) PCT Filed: Dec. 13, 2013
(86) PCT No.: PCT/CN2013/089357

§ 371 Date: Apr. 7, 2014

(30) Foreign Application Priority Data
Dec. 10, 2013 (CN) 201310660994.5
Dec. 10, 2013 (CN) 201320804174.4

(51) Int. Cl. F16L 11/127; F16L 11/10; D04B 1/22

(52) U.S. Cl. CPC F16L 11/127; D04B 1/225; F16L 11/10

(57) ABSTRACT

The present invention provides a fracturing fluid transport hose, a method for manufacturing same, and a co-extrusion mould. The method for manufacturing a fracturing fluid transport hose according to the present invention includes the following steps of: (1) drying, agitating and color matching of an outer adhesive layer; (2) drying, agitating and color matching of an inner adhesive layer; (3) producing a reinforcement layer: knitting a tubular reinforcement layer according to a product design specification parameter; and (4) producing a final product: sleeving the reinforcement layer on a mould core of a co-extrusion mould, suctioning the dried granules in step (1) and step (2) into two extruders respectively, and starting the extruders and a dragger, so that the reinforcement layer, the outer adhesive layer granules and the inner adhesive layer granules pass through a co-extrusion device together to obtain a product. Different types of materials may be used as the outer adhesive layer and the inner adhesive layer of the present invention, and different combinations of outer adhesive layer and inner adhesive layer materials can meet more needs and also lower product costs. The hose can be produced in any length and has small elongation. The product has a stable size. The hose can bear great pressure and transport a large flow, can be easily connected, and has a small volume for storage and transport.

### BACKGROUND

1. Technical Field

The present invention relates to the field of thermoplastic elastomers, and in particular, to the field of manufacturing hoses and fire hoses.

2. Related Art

A hydraulic fracturing technology is currently the only method for commercially exploiting shale oil and gas. After a high-pressure liquid is injected into a drilled well and cracks a rock stratum, a proppant in the high-pressure liquid can sustain a crack so that the crack becomes a high-speed permeation passage for leading oil and gas to the drilled well. A fracturing fluid used in the hydraulic fracturing method for exploiting shale oil and gas is mainly made up of water, sand and chemical additives (salt and some emulsifiers), where the water and the sand take up over 99%. Exploiting shale oil and gas requires a large quantity of the fracturing fluid, with each shale gas well needing to consume four or five million gallons (1 gallon is about 3.78 liters) of the fracturing fluid to crack shale.

At present, a metal pipe is usually used for long-distance (about 10 miles) transport during shale oil and gas exploitation. Defects of this method are that a lot of laying work needs to be done and laying a pipe in some sections such as slopes, ravines and ponds is difficult, and more importantly, a joint of pipes can be easily cracked, causing water leakage resulting in soil contamination. Besides, toxic brine, which has a concentration of 6 times that of sea water, in the waste water may have a serious effect on the environment.

SUMMARY

The present invention provides a fracturing fluid transport hose, a method for manufacturing same, and a co-extrusion mould, so as to solve the foregoing problem. The hose of the present invention has great strength and a greater length and caliber. Further, the hose can bear high pressure and transport a large flow, can be easily connected, has good resistance to weather and chemicals, and is adaptable to different landforms. When not in use, the hose is flat and can be easily rolled up, thereby having a small volume for storage and transport.

The foregoing objective is achieved through the following technical solutions:

A method for manufacturing a fracturing fluid transport hose is provided. The method includes the following steps of:

(1) drying, agitating and color matching of an outer adhesive layer: putting outer adhesive layer granules and color masterbatch granules into an agitator in a proportion of 100:(0-1.5), agitating the outer adhesive layer granules and the color masterbatch granules, then suctioning the outer adhesive layer granules and the color masterbatch granules into a dryer, and drying the outer adhesive layer granules and the color masterbatch granules in a temperature of 70 to 110° C. for 1 to 6 hours;

(2) drying, agitating and color matching of an inner adhesive layer: proportionally putting inner adhesive layer granules and color masterbatch granules into an agitator, agitating the inner adhesive layer granules and the color masterbatch granules, then suctioning the inner adhesive layer granules and the color masterbatch granules into a dryer, and drying the inner adhesive layer granules and the color masterbatch granules in a temperature of 70 to 110° C. for 1 to 6 hours;

(3) producing a reinforcement layer: knitting a tubular reinforcement layer according to a product design specification parameter; and

(4) producing a final product: sleeving the reinforcement layer on a mould core of a co-extrusion mould, suctioning the dried granules in step (1) and step (2) into two extruders respectively, and starting the extruders and a dragger, so that the reinforcement layer, the outer adhesive layer granules and the inner adhesive layer granules pass through a co-extrusion device together to obtain a product.

In the method for manufacturing a fracturing fluid transport hose, the outer adhesive layer granules in step (1) are TPU granules or an alloy of TPU and PVC, and the inner adhesive layer granules in step (2) are TPU granules or an alloy of TPU/PVC or PVC or PVC/Buna-N, where in the alloy of TPU and PVC, TPU:PVC =100:0-70, and in the PVC/Buna-N, PVC:Buna-N =100:0-70; and a temperature at which the co-extrusion operation is performed in step (4) is 150 to 210° C.

In the method for manufacturing a fracturing fluid transport hose, the reinforcement layer in step (3) is knitted into a tubular shape by using warp threads and weft threads, and the warp threads or weft threads are polyester filaments and/or nylon filaments and/or aramid fibers.

A fracturing fluid transport hose manufactured by using the method is provided. The hose includes, from outside to inside, an outer adhesive layer, a reinforcement layer, and an inner adhesive layer, where the thickness of the outer adhesive layer is 0.5-4.0 mm, the thickness of the reinforcement layer is 1.5-5.0 mm, the thickness of the inner adhesive layer is 0.5-4.0 mm, and the outer adhesive layer and the inner adhesive layer are obtained by co-extruding the outer adhesive layer and the inner adhesive layer onto the reinforcement layer with a co-extrusion device.

In the fracturing fluid transport hose, the reinforcement layer is knitted into a tubular shape by using warp threads and weft threads.

In the fracturing fluid transport hose, copper wires are evenly knitted in an axial direction in the reinforcement layer to achieve an antistatic effect.

A co-extrusion device for manufacturing the fracturing fluid transport hose is provided. The co-extrusion device includes a mounting support, a derrick is mounted in the middle of the mounting support, an inner layer extruder and an outer layer extruder are mounted at two ends of the mounting support respectively, an extrusion mould is mounted at a lower portion of the derrick, the inner layer extruder and the outer layer extruder are connected to the extrusion mould, and the extrusion mould is connected to a dragger.

In the co-extrusion device for manufacturing the fracturing fluid transport hose, the extrusion mould includes a mould core for sleeving the reinforcement layer, a positioning ring is sleeved on the mould core, the middle of the positioning ring is provided with a group of long through holes, a mould root is sleeved on the positioning ring, the outside of the mould root is provided with an inner cavity casing, an inner layer flow channel is formed between the mould root and the inner cavity casing, the inner layer flow channel is communicated with the long through holes and the inner layer extruder, the outside of the inner cavity casing is provided with an outer cavity casing, an outer layer flow channel is formed between the inner cavity casing and the outer cavity casing, and the outer layer flow channel is communicated with the outer layer extruder.

In the co-extrusion device for manufacturing the fracturing fluid transport hose, a gap between the positioning ring and the inner cavity casing is equal to the thickness of the reinforcement layer.

Beneficial effects are as follows:

1. The fracturing fluid transport hose of the present invention includes, from outside to inside, an outer adhesive layer, a reinforcement layer and an inner adhesive layer, where the outer adhesive layer and the inner adhesive layer may be made of different materials. A material with resistance to corrosion caused by chemical media and oil may be used as the inner adhesive layer, while a material with resistance to weather, ozone, wear and penetration may be used as the outer adhesive layer. In this way, the advantages of the materials are made full use of The product of the present invention can be manufactured in any length, and parts of the hose are uniform-sized, and more importantly, the product has very small elongation and therefore has good product stability when transporting a medium.

2. The hose manufactured using the method of the present invention is light and soft and has good resistance to wear, corrosion and weather. Besides, the hose can be connected through various standard fittings, and can be easily rolled up, assembled and disassembled. The hose of this patent is produced using a belt-turning technology; therefore, the product can be of any length and in different specifications such as 200 mm (8″), 250 mm (10″), 300 mm (12″), 400 mm (16″) and 600 mm (24″).

3. The present invention designs a dedicated co-extrusion device, which is easy to operate and has high efficiency.

### BRIEF DESCRIPTION OF THE DRAWINGS

FIG. 1 is a schematic structural diagram of a co-extrusion device according to the present invention;

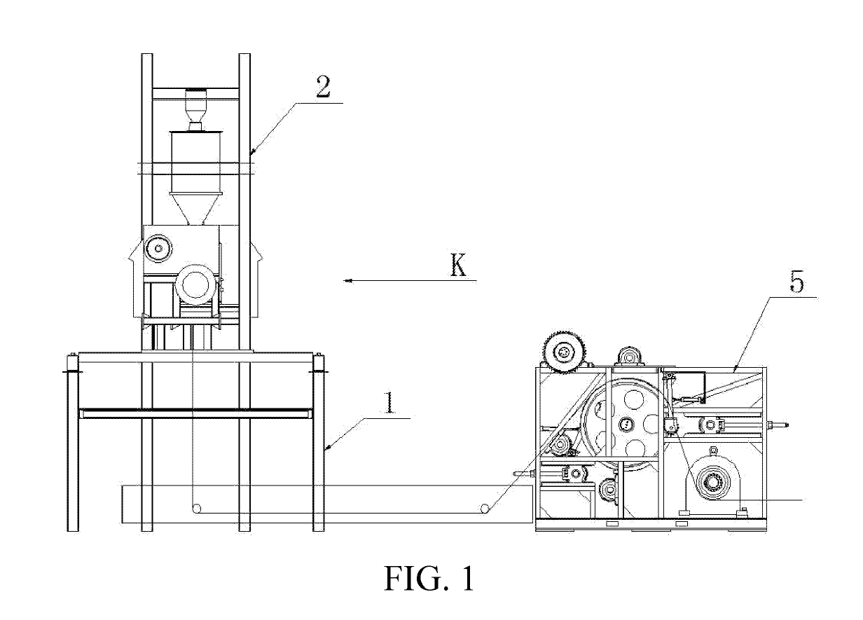

FIG. 2 is a K-direction diagram of FIG. 1; and

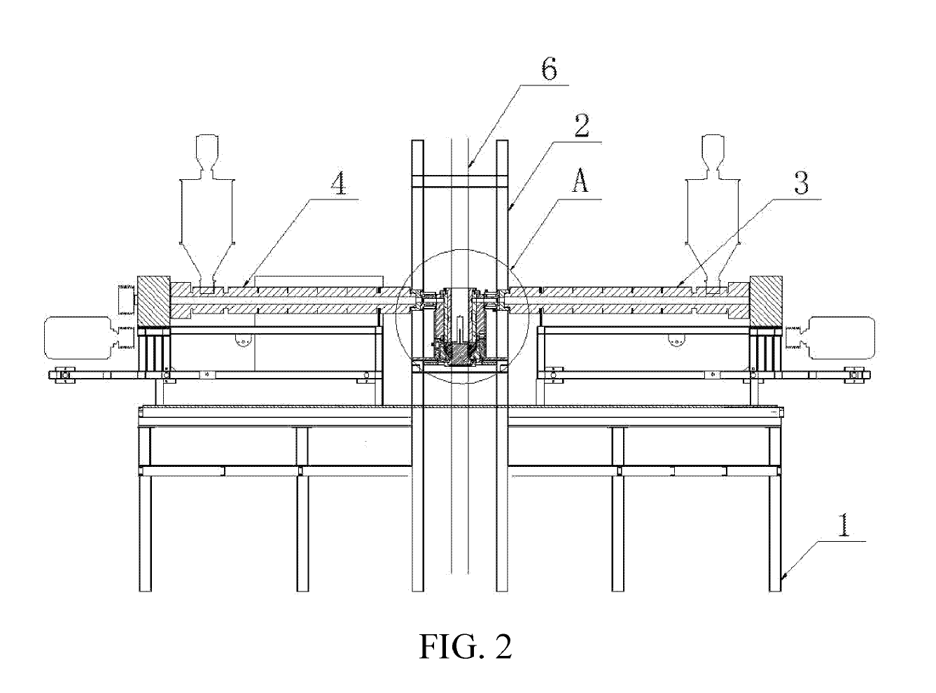

FIG. 3 is an enlarged diagram of A in FIG. 2.

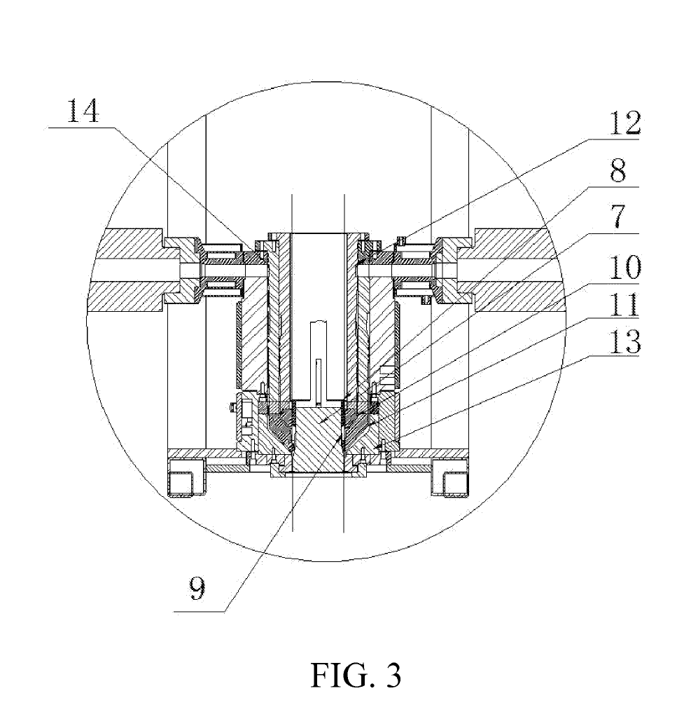

In the drawings, reference numerals are: 1: mounting support; 2: derrick; 3: inner layer extruder; 4: outer layer extruder; 5: dragger; 6: reinforcement layer; 7: mould core; 8: positioning ring; 9: long through hole; 10: mould root; 11: inner cavity casing; 12: inner layer flow channel; 13: outer cavity casing; and 14: outer layer flow channel.

### DETAILED DESCRIPTION

### Embodiment 1

A method for manufacturing a fracturing fluid transport hose is provided. The method includes the following steps:

(1) drying, agitating and color matching of an outer adhesive layer: putting outer adhesive layer granules and color masterbatch granules into an agitator in a proportion of 100:(0-1.5), agitating the outer adhesive layer granules and the color masterbatch granules, then suctioning the outer adhesive layer granules and the color masterbatch granules into a dryer, and drying the outer adhesive layer granules and the color masterbatch granules in a temperature of 70 to 110° C. for 1 to 6 hours;

(2) drying, agitating and color matching of an inner adhesive layer: proportionally putting inner adhesive layer granules and color masterbatch granules into an agitator, agitating the inner adhesive layer granules and the color masterbatch granules, then suctioning the inner adhesive layer granules and the color masterbatch granules into a dryer, and drying the inner adhesive layer granules and the color masterbatch granules in a temperature of 70 to 110° C. for 1 to 6 hours;

(3) producing a reinforcement layer: knitting a tubular reinforcement layer according to a product design specification parameter; and (4) producing a final product: sleeving the reinforcement layer on a mould core of a co-extrusion mould, suctioning the dried granules in step (1) and step (2) into two extruders respectively, and starting the extruders and a dragger, so that the reinforcement layer, the outer adhesive layer granules and the inner adhesive layer granules pass through a co-extrusion device together to obtain a product.

In the method for manufacturing a fracturing fluid transport hose, the outer adhesive layer granules in step (1) are TPU granules or an alloy of TPU and PVC, and the inner adhesive layer granules in step (2) are TPU granules or an alloy of TPU/PVC or

PVC or PVC/Buna-N, where in the alloy of TPU and PVC, TPU:PVC =100:0-70, and in the PVC/Buna-N, PVC:Buna-N =100:0-70; and a temperature at which the co-extrusion operation is performed in step (4) is 150 to 210° C.

In the method for manufacturing a fracturing fluid transport hose, the reinforcement layer in step (3) is knitted into a tubular shape by using warp threads and weft threads, and the warp threads or weft threads are polyester filaments and/or nylon filaments and/or aramid fibers.

A fracturing fluid transport hose manufactured by using the method is provided. The hose includes, from outside to inside, an outer adhesive layer, a reinforcement layer, and an inner adhesive layer, where the thickness of the outer adhesive layer is 0.5-4.0 mm, the thickness of the reinforcement layer is 1.5-5.0 mm, the thickness of the inner adhesive layer is 0.5-4.0 mm, and the outer adhesive layer and the inner adhesive layer are obtained by co-extruding the outer adhesive layer and the inner adhesive layer onto the reinforcement layer with a co-extrusion device.

In the fracturing fluid transport hose, the reinforcement layer is knitted into a tubular shape by using warp threads and weft threads.

### Embodiment 2

A difference between this embodiment and Embodiment 1 is that copper wires are evenly knitted in an axial direction in the reinforcement layer of the fracturing fluid transport hose to achieve an antistatic effect.

### Embodiment 3

The present invention further provides a co-extrusion device for manufacturing the fracturing fluid transport hose. The co-extrusion device includes a mounting support 1, a derrick 2 is mounted in the middle of the mounting support, an inner layer extruder 3 and an outer layer extruder 4 are mounted at two ends of the mounting support respectively, an extrusion mould is mounted at a lower portion of the derrick, the inner layer extruder and the outer layer extruder are connected to the extrusion mould, and the extrusion mould is connected to a dragger 5.

In the co-extrusion device for manufacturing the fracturing fluid transport hose, the extrusion mould includes a mould core for sleeving the reinforcement layer 6, a positioning ring is sleeved on the mould core 7, the middle of the positioning ring 8 is provided with a group of long through holes 9, a mould root 10 is sleeved on the positioning ring, the outside of the mould root is provided with an inner cavity casing 11, an inner layer flow channel 12 is formed between the mould root and the inner cavity casing, the inner layer flow channel is communicated with the long through holes and the inner layer extruder, the outside of the inner cavity casing is provided with an outer cavity casing 13, an outer layer flow channel 14 is formed between the inner cavity casing and the outer cavity casing, and the outer layer flow channel is communicated with the outer layer extruder.

In the co-extrusion device for manufacturing the fracturing fluid transport hose, a gap between the positioning ring and the inner cavity casing is equal to the thickness of the reinforcement layer. p During production, the reinforcement layer is sleeved on the mould core of the co-extrusion mould, the dried granules in step (1) and step (2) are suctioned into the two extruders respectively, and the extruders and the dragger are started; when the inner adhesive layer along the inner layer flow channel enters the rectangular holes of the positioning ring, because the inner adhesive layer is under a pressure above from the extruder and the gap between the inner cavity casing below and the positioning ring is equal to the thickness of the reinforcement layer, the extruded inner adhesive layer permeates the reinforcement layer, flows down along a gap between the positioning ring and the mould core, and is finally extruded at an inner side of the reinforcement layer, while the outer adhesive layer granules directly flow down along the outer layer flow channel after coming out of the outer layer extruder and are finally extruded at an outer side of the reinforcement layer.

1. A method for manufacturing a fracturing fluid transport hose, wherein the method comprises the following steps of:
(1) drying, agitating and color matching of an outer adhesive layer: putting outer adhesive layer granules and color masterbatch granules into an agitator in a proportion of 100:(0-1.5), agitating the outer adhesive layer granules and the color masterbatch granules, then suctioning the outer adhesive layer granules and the color masterbatch granules into a dryer, and drying the outer adhesive layer granules and the color masterbatch granules in a temperature of 70to 110° C. for 1 to 6 hours;
(2) drying, agitating and color matching of an inner adhesive layer: proportionally putting inner adhesive layer granules and color masterbatch granules into an agitator, agitating the inner adhesive layer granules and the color masterbatch granules, then suctioning the inner adhesive layer granules and the color masterbatch granules into a dryer, and drying the inner adhesive layer granules and the color masterbatch granules in a temperature of 70 to 110° C. for 1 to 6 hours;
(3) producing a reinforcement layer: knitting a tubular reinforcement layer according to a product design specification parameter; and
(4) producing a final product: sleeving the reinforcement layer on a mould core of a co-extrusion mould, suctioning the dried granules in step (1) and step (2) into two extruders respectively, and starting the extruders and a dragger, so that the reinforcement layer, the outer adhesive layer granules and the inner adhesive layer granules pass through a co-extrusion device together to obtain a product.

2. The method for manufacturing a fracturing fluid transport hose according to claim 1, wherein the outer adhesive layer granules in step (1) are TPU granules or an alloy of TPU and PVC, and the inner adhesive layer granules in step (2) are TPU granules or an alloy of TPU/PVC or PVC or PVC/Buna-N, wherein in the alloy of TPU and PVC, TPU:PVC =100:0-70, and in the PVC/Buna-N, PVC:Buna-N =100:0-70; and a temperature at which the co-extrusion operation is performed in step (4) is 150 to 210° C.

3. The method for manufacturing a fracturing fluid transport hose according to claim 1 or 2, wherein the reinforcement layer in step (3) is knitted into a tubular shape by using warp threads and weft threads, and the warp threads or weft threads are polyester filaments and/or nylon filaments and/or aramid fibers.

4. A fracturing fluid transport hose manufactured by using the method, wherein the hose comprises, from outside to inside, an outer adhesive layer, a reinforcement layer and an inner adhesive layer, wherein the thickness of the outer adhesive layer is 0.5-4.0 mm, the thickness of the reinforcement layer is 1.5-5.0 mm, the thickness of the inner adhesive layer is 0.5-4.0 mm, and the outer adhesive layer and the inner adhesive layer are obtained by co-extruding the outer adhesive layer and the inner adhesive layer onto the reinforcement layer with a co-extrusion device.

5. The fracturing fluid transport hose according to claim 4, wherein the reinforcement layer is knitted into a tubular shape by using warp threads and weft threads.

6. The fracturing fluid transport hose according to claim 4, wherein copper wires are evenly knitted in an axial direction in the reinforcement layer to achieve an antistatic effect.

7. A co-extrusion device for manufacturing the fracturing fluid transport hose, wherein the co-extrusion device comprises a mounting support, a derrick is mounted in the middle of the mounting support, an inner layer extruder and an outer layer extruder are mounted at two ends of the mounting support respectively, an extrusion mould is mounted at a lower portion of the derrick, the inner layer extruder and the outer layer extruder are connected to the extrusion mould, and the extrusion mould is connected to a dragger.

8. The co-extrusion device for manufacturing the fracturing fluid transport hose according to claim 7, wherein the extrusion mould comprises a mould core for sleeving the reinforcement layer, a positioning ring is sleeved on the mould core, the middle of the positioning ring is provided with a group of long through holes, a mould root is sleeved on the positioning ring, the outside of the mould root is provided with an inner cavity casing, an inner layer flow channel is formed between the mould root and the inner cavity casing, the inner layer flow channel is communicated with the long through holes and the inner layer extruder, the outside of the inner cavity casing is provided with an outer cavity casing, an outer layer flow channel is formed between the inner cavity casing and the outer cavity casing, and the outer layer flow channel is communicated with the outer layer extruder.

9. The co-extrusion device for manufacturing the fracturing fluid transport hose according to claim 7, wherein a gap between the positioning ring and the inner cavity casing is equal to the thickness of the reinforcement layer.

10. The method for manufacturing a fracturing fluid transport hose according to claim 2, wherein the reinforcement layer in step (3) is knitted into a tubular shape by using warp threads and weft threads, and the warp threads or weft threads are polyester filaments and/or nylon filaments and/or aramid fibers.

11. The fracturing fluid transport hose according to claim 5, wherein copper wires are evenly knitted in an axial direction in the reinforcement layer to achieve an antistatic effect.

12. The co-extrusion device for manufacturing the fracturing fluid transport hose according to claim 8, wherein a gap between the positioning ring and the inner cavity casing is equal to the thickness of the reinforcement layer.
